(19) United States
(12) Patent Application Publication
(10) Pub. No.: US 2024/0079658 A1
(43) Pub. Date: Mar. 7, 2024

(54) BATTERY AND STACKED BATTERY

(71) Applicant: Panasonic Intellectual Property Management Co., Ltd., Osaka (JP)

(72) Inventor: Eiichi KOGA, Osaka (JP)

(21) Appl. No.: 18/506,350

(22) Filed: Nov. 10, 2023

Related U.S. Application Data
(63) Continuation of application No. PCT/JP2022/011143, filed on Mar. 11, 2022.

(30) Foreign Application Priority Data
May 10, 2021 (JP) 2021-080073

(51) Int. Cl. H01M 10/0585; H01M 4/36; H01M 4/62; H01M 4/66; H01M 50/204; H01M 50/533; H01M 50/534; H01M 50/54

(52) U.S. Cl. CPC H01M 10/0585; H01M 4/366; H01M 4/62; H01M 4/661; H01M 50/204; H01M 50/533; H01M 50/534; H01M 50/54; H01M 2300/0065

(57) ABSTRACT

A battery of the present disclosure includes a first electrode layer, a first solid electrolyte layer, and a second electrode layer in this order. The first electrode layer includes: a first active material layer; a second active material layer positioned between the first active material layer and the first solid electrolyte layer, the second active material layer having the same polarity as the first active material layer has; and a second solid electrolyte layer positioned between the first active material layer and the second active material layer. The second solid electrolyte layer is continuous with the first solid electrolyte layer. A stacked battery of the present disclosure includes a plurality of the batteries, and the plurality of batteries are stacked so as to be electrically connected in series or in parallel.

### CROSS-REFERENCE TO RELATED APPLICATIONS

This application is a continuation of PCT/JP2022/011143 filed on Mar. 11, 2022, which claims foreign priority of Japanese Patent Application No. 2021-080073 filed on May 10, 2021, the entire contents of both of which are incorporated herein by reference.

### BACKGROUND OF THE INVENTION

### 1. Field of the Invention

The present disclosure relates to a battery and a stacked battery.

### 2. Description of Related Art

Battery capacity, voltage, and energy amount can be enhanced by increasing the active material amount in batteries or connecting batteries in series or in parallel. An example of a technique relating to such a battery structure or connection is WO 2018/181827 A1 that discloses an all-solid-state battery in which positive electrodes and negative electrodes are alternately stacked with a solid electrolyte therebetween and are connected in parallel. JP 2020-4686 A discloses an all-solid-state battery having a structure in which mixture layers containing an active material are stacked.

### SUMMARY OF THE INVENTION

The present disclosure aims to provide a battery having a structure suitable for improving the input and output characteristics.

A battery of the present disclosure includes, in the following order:
a first electrode layer;
a first solid electrolyte layer; and
a second electrode layer, wherein
the first electrode layer includes:
a first active material layer;
a second active material layer positioned between the first active material layer and the first solid electrolyte layer, the second active material layer having the same polarity as the first active material layer has; and
a second solid electrolyte layer positioned between the first active material layer and the second active material layer, and
the second solid electrolyte layer is continuous with the first solid electrolyte layer.

The present disclosure provides a battery having a structure suitable for improving the input and output characteristics.

### BRIEF DESCRIPTION OF THE DRAWINGS

FIG. 1 schematically shows the configuration of a battery 1000 according to Embodiment 1.

FIG. 2 schematically shows the configuration of a battery 2000 according to Embodiment 2.

FIG. 3 schematically shows the configuration of a battery 3000 according to Embodiment 3.

FIG. 4 schematically shows the configuration of a battery 4000 according to Embodiment 4.

FIG. 5 schematically shows the configuration of a stacked battery 5000 according to Embodiment 5.

FIG. 6 schematically shows the configuration of a stacked battery 6000 of a modification according to Embodiment 5.

### DETAILED DESCRIPTION

Embodiments of the present disclosure will be specifically described below with reference to the drawings.

The embodiments to be described below each illustrate a generic or specific example. The numerical values, shapes, materials, constituent elements, arrangement positions of the constituent elements, and manners of connection of the constituent elements, etc. which will be indicated in the embodiments below are only illustrative, and are not intended to limit the present disclosure.

In the present specification, terms such as parallel representing the relations between elements, terms such as rectangular parallelepiped representing the shapes of elements, and numerical ranges are not expressions representing only their strict meanings, but are intended to include even substantial equivalents, for example, even variations of about several percentage.

The drawings are not necessarily strict. In the drawings, substantially identical constituent elements are assigned with the same reference numerals, and redundant description thereof will be omitted or simplified.

In the present specification and drawings, the x axis, the y axis, and the z axis indicate the three axes in a three-dimensional orthogonal coordinate system. In the embodiments, the z-axis direction is defined as the thickness direction of the battery. Moreover, in the present specification, the “thickness direction” refers to a direction perpendicular to the plane up to which the layers are stacked in the battery, unless specifically stated otherwise.

In the present specification, the phrase “in plan view” means that the battery is viewed along the stacking direction of layers in the battery, unless specifically stated otherwise. In the present specification, the “thickness” refers to the length of the battery and the layers in the stacking direction, unless specifically stated otherwise.

In the present specification, the “side surface” and the “principal surface” of the battery respectively refer to the surface along the stacking direction and the surface other than the side surface, unless specifically stated otherwise.

In the present specification, “in” and “out” in the terms “inward”, “outward”, and the like respectively indicate the side close to the center of the battery and the side close to the periphery of the battery when the battery is viewed along the stacking direction in the battery.

In the present specification, the terms “upper” and “lower” in the battery configuration respectively do not mean being in the upward direction (vertically above) and being in the downward direction (vertically below) in the absolute spatial recognition, but are used as the terms defined by the relative positional relation based on the stacking order in the stacked structure. Moreover, the terms “upper” and “lower” are applied not only in the case where two constituent elements are disposed in close and direct contact with each other, but also in the case where two constituent elements are disposed with a space therebetween and another constituent element is present between the two constituent elements.

### Embodiment 1

A battery according to Embodiment 1 will be described.

The battery according to Embodiment 1 includes a first electrode layer, a first solid electrolyte layer, and a second electrode layer in this order. The first electrode layer includes a first active material layer, a second active material layer, and a second solid electrolyte layer. The second active material layer is positioned between the first active material layer and the first solid electrolyte layer. The first active material layer and the second active material layer have the same polarity. The second solid electrolyte layer is positioned between the first active material layer and the second active material layer. The second solid electrolyte layer is continuous with the first solid electrolyte layer.

In the battery according to Embodiment 1, the first electrode includes the first active material layer and the second active material layer, and the second solid electrolyte layer is positioned between the first active material layer and the second active material layer. According to this configuration, in the battery according to Embodiment 1, even with an increased capacity by increasing the active material amount, Li ions are easily intercalated and deintercalated, through the second solid electrolyte layer, into and from even the active material contained in the first active material layer, which is provided farther from the first solid electrolyte layer. That is, the active material contained in the first electrode can be efficiently used for the battery reaction. Therefore, according to the above configuration, the battery according to Embodiment 1, for example, even with a reduced size and an increased capacity, can achieve excellent input and output characteristics.

In conventional all-solid-state batteries, the battery capacity and energy have been enhanced by increasing the active material amount or connecting batteries in parallel or in series. However, in the case where the thickness of the active material layer is increased, intercalation and deintercalation of Li ions into and from the active material layer are difficult, which causes difficulties in charge and discharge at a high rate. Moreover, connecting batteries causes difficulties in size reduction. Especially in the case where batteries are connected in parallel with a lead wire or the like, the size reduction is more difficult. Furthermore, in a wired portion of a lead wire, a short circuit and damage tend to occur, which presents a problem with reliability. Moreover, Li metal accumulated around the outermost layer of the active material layer is sometimes deposited to cause a short circuit. These problems tend to become more apparent as battery size reduction, capacity increase, or energy increase proceeds.

As described in 2. Description of Related Art, WO 2018/181827 A1 discloses an all-solid-state battery in which positive electrodes and negative electrodes are alternately stacked with a solid electrolyte therebetween and are connected in parallel. This battery has a structure in which electrode layers and counter electrode layers are alternately disposed so as to face each other, and accordingly is completely different in configuration from the battery of the present disclosure in which active material layers having the same polarity are stacked. In the all-solid-state battery disclosed in WO 2018/181827 A1, the positive electrodes and the negative electrodes are alternately stacked, that is, the adjacent active material layers are active material layers having polarities different from each other. This generates, between the layers, stress caused by expansion and contraction of the positive electrodes and the negative electrodes facing each other in the upper and lower direction, and consequently tends to cause a structural defect.

In contrast, in the battery of the present disclosure such as the battery according to Embodiment 1 described above, the first active material layer and the second active material layer, which are active material layers having the same polarity, are stacked, and the solid electrolyte positioned between the first active material layer and the second active material layer is present. According to this configuration, Li ions are easily intercalated and deintercalated into and from both the first active material layer and the second active material layer. Furthermore, according to such a configuration, for example, even in the case where the active material amount in the first electrode is increased in order to increase the capacity, Li ions are easily intercalated and deintercalated into and from even the active material positioned far from the first solid electrolyte layer, that is, the active material of the first active material layer. Therefore, in the battery of the present disclosure, for example, even with an increased capacity by increasing the active material amount in the first electrode, it is possible to suppress a deterioration in charge and discharge characteristics at a high rate. That is, according to the battery of the present disclosure, for example, even with a reduced size and an increased capacity, it is possible to achieve a battery having excellent input and output characteristics. Moreover, the first active material layer and the second active material layer adjacent to each other are active material layers having the same polarity, and the solid electrolyte that is soft is present between the first active material layer and the second active material layer. This tends not to cause a structural defect. Therefore, the battery of the present disclosure is excellent in reliability as well.

JP 2020-4686 A discloses an all-solid-state battery having a structure in which mixture layers containing an active material are stacked. This stacked structure is obtained by applying mixture layers having different active material proportions one on top of another. Accordingly, thickening the mixture layers for capacity increase unfortunately makes it difficult to migrate Li present at deep positions (i.e., positions farther from the solid electrolyte layer) in the mixture layers. That is, in the case where a battery having the structure disclosed in JP 2020-4686 A is, for example, increased in capacity, the input and output characteristics become deteriorated.

In contrast, the battery of the present disclosure has the configuration, as described above, in which the first active material layer and the second active material layer, which are active material layers having the same polarity, are stacked, and the solid electrolyte positioned between the first active material layer and the second active material layer is present. According to this configuration, Li ions are favorably intercalated and deintercalated into and from the active material at the deep positions. Therefore, according to such a configuration, it is also possible to increase the capacity while suppressing a deterioration in input and output characteristics. Moreover, according to the battery of the present disclosure with the above configuration, capacity increase by using a unit cell can be achieved through connection of active material layers in the electrode. That is, capacity increase does not require to stack unit cells. Consequently, it is also possible to avoid the above problem due to wiring of a lead wire. Therefore, according to the battery of the present disclosure, it is possible to achieve a high-reliability battery having excellent input and output characteristics, for example, even with a reduced size and an increased capacity.

A battery 1000 will be described as an example of the battery according to Embodiment 1, with reference to the drawings.

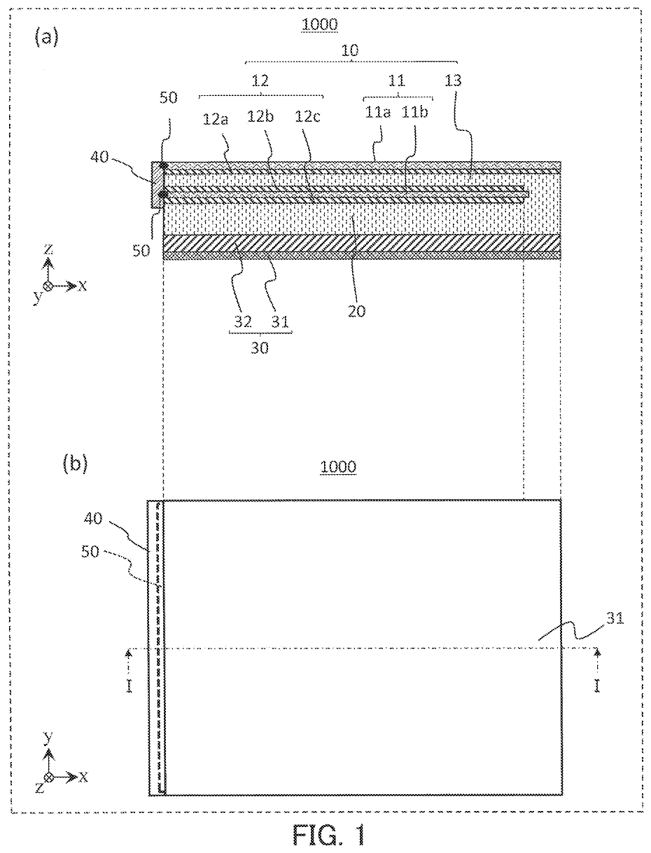

FIG. 1 schematically shows the configuration of the battery 1000 according to Embodiment 1. FIG. 1(a) is a cross-sectional view of the battery 1000 according to Embodiment 1. FIG. 1(b) is a plan view of the battery 1000 as viewed from below in the z-axis direction. In FIG. 1(a), a cross section at the position indicated by line I-I in FIG. 1(b) is shown.

As shown in FIG. 1, the battery 1000 includes a first electrode layer 10, a first solid electrolyte layer 20, and a second electrode layer 30 in this order. The first electrode layer 10 includes a first current collector 11a, a first active material layer 12a, a second solid electrolyte layer 13, a second active material layer 12b, a second current collector 11b, and a third active material layer 12c in this order. The second electrode layer 30 includes a current collector 31 and an active material layer 32. The first solid electrolyte layer 20 is disposed between the first electrode layer 10 and the second electrode layer 30. More specifically, the first solid electrolyte layer 20 is disposed between the third active material layer 12c of the first electrode layer 10 and the active material layer 32 of the second electrode layer 30. In the first electrode layer 10, the second solid electrolyte layer 13 is provided between the first active material layer 12a and the second active material layer 12b. In the battery 1000 shown in FIG. 1, the first active material layer 12a, the second active material layer 12b, and the third active material layer 12c, which are included in the first electrode layer 10, are separate from each other and not in direct contact with each other. The second current collector 11b is disposed between the second active material layer 12b and the third active material layer 12c, and is in contact with the second active material layer 12b and the third active material layer 12c. The first active material layer 12a, the second active material layer 12b, and the third active material layer 12c have the same polarity.

In the battery 1000 shown in FIG. 1, the first active material layer 12a and the second active material layer 12b are separate from each other and not in direct contact with each other, and the second solid electrolyte layer 13 is provided in the entire region between the first active material layer 12a and the second active material layer 12b. However, the battery 1000 is not limited to this configuration, and the first active material layer 12a and the second active material layer 12b may have respective portions in direct contact with each other. In this case, the second solid electrolyte layer 13 should be provided in a region that is positioned between the first active material layer 12a and the second active material layer 12b and separates the first active material layer 12a and the second active material layer 12b. To obtain further favorable input and output characteristics, the region, which separates the first active material layer 12a and the second active material layer 12b, may account for, for example, 50% or more of the area of the principal surfaces of the first active material layer 12a and the second active material layer 12b facing each other. Similarly, the second active material layer 12b and the third active material layer 12c may have respective portions in direct contact with each other.

In the first electrode layer 10, for example, the plurality of active material layers are provided so as to be separate from each other. Consequently, it is possible to form the first electrode layer 10 that is thin and has a high capacity, for example, by a known stacking process. Furthermore, in the first electrode layer 10, since expansion and contraction of the active material layers due to charge and discharge can be spread and absorbed in the layers constituting the first electrode layer 10, a structural defect such as delamination or cracking of the electrode layer can be suppressed. Therefore, the battery 1000 can have a high capacity and excellent input and output characteristics and can also have an excellent reliability.

The first current collector 11a and the second current collector 11b, for example, are electrically connected to each other with a connection electrode 40. That is, the connection electrode 40, for example, electrically connects the first active material layer 12a and the second active material layer 12b to each other. For example, the first current collector 11a may be electrically connected in parallel to the second current collector 11b, as shown in FIG. 1. That is, the first active material layer 12a may be electrically connected in parallel to the second active material layer 12b. Between the first current collector 11a and the connection electrode 40, a reaction layer 50 is disposed, for example. Owing to inclusion of the connection electrode 40, the capacities of the active material layers are synthesized without using lead terminals outside the battery. Therefore, it is possible to achieve a highly reliable battery with a reduced size and a high capacity.

The connection electrode 40 may be provided on a side surface of the battery 1000, as shown in FIG. 1. In this case, the first active material layer 12a and the second active material layer 12b can be connected to each other by using a terminal electrode formed on the side surface of the battery 1000. Therefore, according to this configuration, it is possible to achieve a high-reliability battery with a reduced size and a high capacity, by end face coating, which is often applied to chip parts. Moreover, heat can be dissipated through the terminal electrode formed on the surface, thereby suppressing a deterioration in characteristics and a deterioration in reliability that are due to heat generation.

For example, one principal surface of the first current collector 11a is in contact with the first active material layer 12a, and the other principal surface opposite to the one principal surface is exposed. Since the first current collector 11a is in contact with the first active material layer 12a, current collection can be efficiently performed. Moreover, heat generated in the first active material layer 12a during operations can be released through the first current collector 11a that is a high-heat conductor, and consequently the reliability is enhanced as well.

In plan view, the second current collector 11b is, for example, smaller than the first current collector 11a. For example, as shown in FIG. 1, the second current collector 11b may not be exposed on an end portion of a side surface of the battery 1000 (i.e., the end portion of the side surface on the right in FIG. 1). In plan view, the second active material layer 12b is, for example, smaller than the first active material layer 12a. The second current collector 11b, the second active material layer 12b, and the third active material layer 12c are provided, for example, so as to retreat inward from the side surface of the battery 1000 opposite to the side surface on which the second current collector 11b and the connection electrode 40 are joined to each other. According to such a configuration, a retreat region resulting from the retreat of the second current collector 11b, the second active material layer 12b, and the third active material layer 12c from the side surface of the battery 1000 can serve, for example, as a path for the first active material layer 12a to exchange Li ions with the second electrode layer 30. For example, in the above retreat region, the second solid electrolyte layer 13 of the first electrode layer can be continuous with the first solid electrolyte layer 20. Moreover, according to this configuration, peeling off of the layers from the side surface of the battery 1000 can be suppressed. For example, a solid electrolyte or the like is provided in the above retreat region, that is, a portion from the side surface of the battery 1000 to the end portions of the second active material layer 12b and the third active material layer 12c, which retreat inward. Consequently, owing to an excellent stress absorbency of the solid electrolyte that is softer than the other constituent materials, it is possible to further suppress delamination that tends to be caused by expansion and contraction due to charge and discharge. The battery 1000 may not include the third active material layer 12c. In this case, the second active material layer 12b may be provided on one principal surface of the second current collector 11b, and the one principal surface faces the first solid electrolyte layer 20 (i.e., may be provided at the position where the third active material layer 12c is disposed in FIG. 1).

The battery 1000 according to Embodiment 1 may have a region where the second current collector 11b is present and the second active material layer 12b is not present in plan view. That is, the second active material layer 12b may be provided on the second current collector 11b and in a region inside the periphery of the second current collector 11b in plan view. According to such a configuration, current collection from the second active material layer 12b can be efficiently performed.

In FIG. 1, the layers constituting the first electrode layer 10, the first solid electrolyte layer 20, and the layers constituting the second electrode layer 30 (i.e., the current collector 31 and the active material layer 32) each have a rectangular parallelepiped structure with a small thickness. That is, the layers are each rectangular in plan view. The shapes of the layers constituting the battery 1000 in plan view are not limited. Examples of shapes other than the rectangular shape include a circular shape, an elliptical shape, and a polygonal shape.

The first electrode layer 10 may be a positive electrode layer. In this case, the first current collector 11a and the second current collector 11b are positive electrode current collectors, and the first active material layer 12a, the second active material layer 12b, and the third active material layer 12c are positive electrode active material layers.

In the case where the first electrode layer 10 is a positive electrode layer, the second electrode layer 30 is a negative electrode layer. That is, the current collector 31 is a negative electrode current collector, and the active material layer 32 is a negative electrode active material layer.

In the present specification, the first current collector 11a and the second current collector 11b, which are included in the first electrode layer 10, and the current collector 31, which is included in the second electrode layer 30, are also hereinafter referred to simply as “current collectors”. Moreover, the first active material layer 12a, the second active material layer 12b, the third active material layer 12c, and the active material layer 32 are also referred to simply as “active material layers”.

The current collectors should be formed of any conductive material. The material of the current collectors is not particularly limited. Examples of the material of the current collectors include stainless steel, nickel, aluminum, iron, titanium, copper, palladium, gold, platinum, and an alloy of two or more of these. The material of the current collectors may include at least one selected from the group consisting of Al, Cu, and Ni. According to this configuration, it is possible to perform current collection with stability relative to charge and discharge operations and with a suppressed resistance loss.

Examples of the shape of the current collectors include a foil shape, a plate shape, and a mesh shape. The material of the current collectors may be selected as appropriate in view of: neither melting nor decomposition in the manufacturing process, at the operating temperature, and at the operating pressure; the battery operating potential to which the current collectors are subjected; and the conductivity. Moreover, the material of the current collectors can be selected also depending on the required tensile strength and heat resistance. The current collectors each may be, for example, a high-strength electrolytic copper foil or a cladding material obtained by stacking dissimilar metal foils.

The current collectors such as the second current collector 11b positioned inside the battery may have at least one selected from the group consisting of a hole and a slit. The active material or the solid electrolyte entering the hole or the slit enhances the anchoring effect of the current collectors. Such an effective action suppresses peeling off of the layers due to expansion and contraction caused by charge and discharge. Moreover, the hole and the slit can also serve as migration paths for Li ions. Furthermore, it is possible to eject, through such a hole and a slit, air that can be contained between the layers in stacking, thereby suppressing delamination. Therefore, a high-reliability battery can be achieved.

The current collectors each may have a thickness of, for example, 10 μm or more and 100 μm or less. The current collectors even with a thickness of less than 10 μm can be used to the extent that handling in the manufacturing process, the characteristic aspects such as the current amount, and the reliability thereof are satisfied. The current collectors, especially the second current collector 11b, should desirably have both principal surfaces roughened in order to enhance the joining properties between the second active material layer 12b and the third active material layer 12c. This suppresses occurrence of a defect in the internal structure, thereby enhancing the reliability. For example, the maximum height Rz may be about equal to the particle size of the active material (e.g., 1 to 10 μm). The side surface of the battery 1000 may be processed into an uneven rough surface in order to enhance the close contact with the connection electrode 40. For example, onto the surface polished with any of polishing papers #800 to #1000, the connection electrode 40 may be applied for formation. The uneven rough surface may have a surface roughness, for example, represented by the maximum height Rz of about 10 to 20 μm. In this case, the surface energy can be spread, and consequently the influence of surface tension can be reduced. This enhances wettability in applying the material of the connection electrode 40 onto the side surface of the battery 1000, and consequently the shape accuracy can be enhanced as well. Moreover, the anchoring effect is enhanced, thereby enhancing reliability in joining between the connection electrode 40 and the side surface of the battery 1000.

The positive electrode active material layer contains a positive electrode active material. The positive electrode active material refers to a material that intercalates or deintercalates metal ions, such as lithium (Li) ions or magnesium (Mg) ions, into or from the crystal structure at a higher potential than the potential of the negative electrode, and is accordingly oxidized or reduced. The positive electrode active material can be selected as appropriate depending on the battery type, and a known positive electrode active material can be used.

The positive electrode active material may be a compound containing lithium and a transition metal element. More specific examples of the compound include an oxide containing lithium and a transition metal element and a phosphate compound containing lithium and a transition metal element. Examples of the oxide containing lithium and a transition metal element include a lithium nickel composite oxide, such as LiNiₓM₁₋ₓO₂ (where M is at least one selected from the group consisting of Co, Al, Mn, V, Cr, Mg, Ca, Ti, Zr, Nb, Mo, and W, and x satisfies 0<x≤1), a layered oxide, such as lithium cobalt oxide (LiCoO₂), lithium nickel oxide (LiNiO₂), or lithium manganese oxide (LiMn₂O₄), and lithium manganese oxide (LiMn₂O₄, Li₂MnO₃, and LiMnO₂) having a spinel structure. An example of the phosphate compound containing lithium and a transition metal element is lithium iron phosphate (LiFePO₄) having an olivine structure. Other examples of the positive electrode active material include sulfur (S) and a sulfide, such as lithium sulfide (Li₂S). In the case where the positive electrode active material is a sulfide, particles of the positive electrode active material may be subjected to coating with or addition of lithium niobate (LiNbO₃) or the like. The positive electrode active material may be only one of these materials or a combination of two or more of the materials.

The positive electrode active material layer, which contains the positive electrode active material, may contain a different additive material. That is, the positive electrode active material layer may be a mixture layer. Examples of the additive material include a solid electrolyte, such as an inorganic solid electrolyte or a sulfide-based solid electrolyte, a conductive additive, such as acetylene black, and a binder, such as polyethylene oxide or polyvinylidene fluoride. By mixing the positive electrode active material with the additive material in a predetermined proportion to form the positive electrode active material layer, it is possible to enhance the lithium-ion conductivity in the positive electrode active material layer and to enhance the electronic conductivity in the positive electrode active material layer. The solid electrolyte can be, for example, a solid electrolyte exemplified as the material of the first solid electrolyte layer 20 described later.

The positive electrode active material layer may have a thickness of, for example, 3 μm or more and 100 μm or less. That is, in the case where the first electrode layer 10 is a positive electrode layer, the first active material layer 12a, the second active material layer 12b, and the third active material layer 12c each may have a thickness of 3 μm or more and 100 μm or less.

The negative electrode active material layer contains a negative electrode active material. The negative electrode active material refers to a material that intercalates or deintercalates metal ions, such as lithium (Li) ions or magnesium (Mg) ions, into or from the crystal structure at a lower potential than the potential of the positive electrode, and is accordingly oxidized or reduced. The negative electrode active material can be selected as appropriate depending on the battery type, and a known negative electrode active material can be used.

Examples of the negative electrode active material include a carbon material, such as natural graphite, artificial graphite, a graphite carbon fiber, or resin baked carbon, and an alloy-based material to be mixed with a solid electrolyte. Examples of the alloy-based material include a lithium alloy, such as LiAl, LiZn, Li₃Bi, Li₃Cd, Li₃Sb, Li₄Si, Li_{4.4}Pb, Li_{4.4}Sn, Li_{0.17}C, or LiC₆, an oxide of lithium and a transition metal element, such as lithium titanate (Li₄Ti₅O₁₂), and a metal oxide, such as zinc oxide (ZnO) or silicon oxide (SiOₓ). The negative electrode active material may be only one of these materials or a combination of two or more of the materials.

The negative electrode active material layer, which contains the negative electrode active material, may contain a different additive material. That is, the negative electrode active material layer may be a mixture layer. Examples of the additive material include a solid electrolyte, such as an inorganic solid electrolyte or a sulfide-based solid electrolyte, a conductive additive, such as acetylene black, and a binder, such as polyethylene oxide or polyvinylidene fluoride. By mixing the negative electrode active material with the additive material in a predetermined proportion to form the negative electrode active material layer, it is possible to enhance the lithium-ion conductivity in the negative electrode active material layer and to enhance the electronic conductivity in the negative electrode active material layer. The solid electrolyte can be, for example, a solid electrolyte exemplified as the material of the first solid electrolyte layer 20 described later.

The negative electrode active material layer may have a thickness of, for example, 3 μm or more and 100 μm or less. That is, in the case where the first electrode layer 10 is a negative electrode layer, the first active material layer 12a, the second active material layer 12b, and the third active material layer 12c each may have a thickness of 3 μm or more and 100 μm or less.

The first solid electrolyte layer 20 is disposed between the first electrode layer 10 and the second electrode layer 30. The first solid electrolyte layer 20 may be in contact with the first electrode layer 10 and the second electrode layer 30. For example, in the configuration shown in FIG. 1, the first solid electrolyte layer 20 may be in contact with the third active material layer 12c of the first electrode layer 10, and may be in contact with the active material layer 32 of the second electrode layer 30.

The first solid electrolyte layer 20 contains a solid electrolyte. The first solid electrolyte layer 20 contains the solid electrolyte, for example, as its main component. Here, the main component refers to the component contained in the first solid electrolyte layer 20 in the highest amount on a mass proportion basis. The solid electrolyte should be any known solid electrolyte for batteries that has no electronic conductivity and has ionic conductivity. The solid electrolyte can be, for example, a solid electrolyte that conducts metal ions, such as lithium ions or magnesium ions. The solid electrolyte should be selected as appropriate depending on the conductive ionic species. Examples of the solid electrolyte include a sulfide-based solid electrolyte, an oxide-based solid electrolyte, and a halogen-based solid electrolyte.

Examples of the sulfide-based solid electrolyte include those based on Li₂S—P₂S₅, Li₂S—SiS₂, Li₂S—B₂S₃, Li₂S—GeS₂, Li₂S—SiS₂-Lil, Li₂S—SiS₂—Li₃PO₄, Li₂S—Ge₂S₂, Li₂S—GeS₂—P₂S₅, and Li₂S—GeS₂—ZnS.

Examples of the oxide-based solid electrolyte include a lithium-containing metal oxide, such as Li₂O—SiO₂ or Li₂O—SiO₂—P₂O₅, a lithium-containing metal nitride, such as LiₓP_{y}O_{1-z}N_{z}, a garnet solid electrolyte material, such as Li₇La₃Zr₂O₁₂ or its element-substituted substance, lithium phosphate (Li₃PO₄), and a lithium-containing transition metal oxide, such as lithium titanium oxide.

An example of the halogen-based solid electrolyte is a compound represented by LiₐMe_{b}Y_{c}Z₆, where mathematic relations a+mb+3c=6 and c>0 are satisfied. Me is at least one selected from the group consisting of metalloid elements and metal elements except Li and Y. Z is at least one selected from the group consisting of F, Cl, Br, and I. The value of m represents the valence of Me.

The “metalloid elements” refer to B, Si, Ge, As, Sb, and Te. The “metal elements” refer to all the elements included in Groups 1 to 12 of the periodic table (except hydrogen) and all the elements included in Groups 13 to 16 of the periodic table (except B, Si, Ge, As, Sb, Te, C, N, P, O, S, and Se).

To enhance the ionic conductivity of the halogen-based solid electrolyte, Me may be at least one selected from the group consisting of Mg, Ca, Sr, Ba, Zn, Sc, Al, Ga, Bi, Zr, Hf, Ti, Sn, Ta, and Nb.

Examples of the halogen-based solid electrolyte include Li₃YCl₆ and Li₃YBr₆. The solid electrolyte may be only one of these materials or a combination of two or more of the materials.

The first solid electrolyte layer 20, which contains the solid electrolyte, may contain, for example, a binder, such as polyethylene oxide or polyvinylidene fluoride.

The first solid electrolyte layer 20 may have a thickness of, for example, 5 μm or more and 150 μm or less.

The first solid electrolyte layer 20 may be constituted of an aggregate of particles of the solid electrolyte. The first solid electrolyte layer 20 may be constituted of a sintered structure of the solid electrolyte.

The material of the connection electrode 40 should have electronic conductivity. To relieve stress on the battery 1000 due to expansion and contraction of the battery element caused by a temperature variation or charge and discharge, a material mixed with a soft resin material can be suitably used. Here, the battery element refers to the basic structure of the battery 1000 composed of the first electrode layer, the first solid electrolyte layer, and the second electrode layer. The connection electrode 40 may contain a first metal material and a resin material. In this case, it is possible to absorb, by the buffering properties of the conductive material, stress caused by the difference in thermal expansion coefficient from the surroundings of the connection portion or impact, thereby enhancing reliability in connection as well. Moreover, it is possible to suppress, by the sealing action of the resin component, penetration of moisture and the like into the battery, thereby suppressing deterioration of the characteristics of the solid electrolyte that are prone to deterioration. Therefore, the battery 1000 having a high reliability can be obtained.

The connection electrode 40 may have a lower Young's modulus than the current collectors have. In this case, stress of the connection electrode 40 caused by expansion and contraction of the battery element due to a temperature variation or charge and discharge is relieved by the buffering properties of the conductive material containing the resin. The connection electrode 40, owing to its deformability, can follow deformation of the cell caused by a thermal shock or the charge and discharge cycle, thereby suppressing peeling off and damage. Moreover, to relieve stress on the battery 1000 and thus to enhance the reliability of the battery 1000, the connection electrode 40 may have a lower Young's modulus than the first solid electrolyte layer 20 has. To relieve stress on the battery 1000 caused by expansion and contraction of the active material layers due to a temperature variation and thus to enhance the reliability of the battery, the connection electrode 40 may have a lower Young's modulus than the active material layers have. The relative relation in Young's modulus between these can be determined from displacement characteristics to the pressure at which a rigid indenter (i.e., probe) is pressed and the magnitude relation in size of the indentation, as in Vickers hardness measurement. Moreover, the connection electrode 40 may be formed of a material in which a solid electrolyte or the like is contained in a conductive resin paste so that the thermal expansion coefficient and softness (e.g., Young's modulus) can be adjusted.

The connection electrode 40 may be formed of a material in which particles of a conductive material or particles of a semiconductor material are contained in a solid electrolyte. In this case, electrical connection can be achieved while stress caused by expansion and contraction of the current collectors due to a temperature variation can be relieved as described above. Therefore, a high-capacity electrode having excellent high-rate characteristics can be achieved.

The connection electrode 40 may contain the first metal material and a solid electrolyte. In this case, the thermal expansion coefficient can be controlled in accordance with the battery 1000, thereby suppressing a structural defect due to thermal shock during a thermal cycle with the battery constituent members. Therefore, a high-reliability battery can be achieved.

The conductive material for the connection electrode 40 can be, for example, a thermosetting conductive paste containing: high-melting and highly conductive metal particles containing Ag, Cu, Ni, Zn, Al, Pd, Au, Pt, or an alloy thereof (first metal material); low-melting metal particles (second metal material); and a resin. The highly conductive metal particles have a melting point of, for example, 400° C. or higher. The low-melting metal particles may have a melting point equal to or lower than the curing temperature of the conductive resin paste, and may have a melting point of 300° C. or lower. Examples of the material of the low-melting metal particles, that is, the second metal material, include Sn, SnZn, SnAg, SnCu, SnAl, SnPb, In, InAg, InZn, InSn, Bi, BiAg, BiNi, BiSn, BiZn, and BiPb. Using a conductive paste containing such low-melting metal particles proceeds with solid-phase and liquid-phase reactions at contact sites between the conductive paste and the current collectors at a thermal curing temperature lower than the melting point of the low-melting metal particles. For example, sintering proceeds even at a temperature equal to or lower than a temperature that is half the metal melting point. This, for example, forms an alloy containing the metal contained in the conductive paste and the metal contained in the current collectors. A diffusion layer containing the alloy, that is, the reaction layer 50 is formed around the connection portion between the current collectors and the connection electrode 40.

The connection electrode 40 may contain, as the second metal material such as the above low-melting metal particles, at least one selected from the group consisting of Sn, In, and Bi. In this case, the connection electrode 40 can be controlled to be soft. This causes the connection electrode 40 to be plastically brought into close contact with the connection portion connecting to the current collectors to increase the contact area. Consequently, the contact resistance can be reduced. Moreover, even when heat and stress act on the connection portion connecting to the current collectors, the connection electrode 40 is plastically deformable. This suppresses a problem of breakage of the connection electrode 40 and thus disconnection.

The reaction layer 50 is a diffusion layer containing an alloy and disposed on the connection portion between the current collectors and the connection electrode 40. For example, in the case where Ag or an Ag alloy is used as the conductive particles in the connection electrode 40 and Cu is used as the current collectors, a highly conductive alloy containing AgCu is formed. Furthermore, by containing the second metal material, which is a low-melting metal, it is also possible to combine the material of the conductive particles and the material of the current collectors to form, around 200° C., the reaction layer 50 containing a low-melting alloy, such as SnAg or SnCu, on the connection portion between Ag (connection electrode) and Cu (current collectors). Thus, the connection electrode 40 and the current collectors are integrally joined by the reaction layer 50 containing the alloy.

According to the above configuration, the connection electrode 40 and the current collectors are seamlessly integrated via the reaction layer 50, and consequently the connection therebetween is stronger than the anchoring effect. Consequently, the battery 1000 is less prone to a problem of disconnection of the members of the battery 1000 due to impact or the difference in thermal expansion between the members caused by a thermal cycle or the like.

The shapes of the highly conductive metal particles as the first metal material and the low-melting metal particles as the second metal material are not limited. Examples of the shapes include a spherical shape, a flaky shape, and an acicular shape. These metal particles having smaller particle sizes proceed with sintering, an alloying reaction, and diffusion of the metal at a lower temperature. Accordingly, the particle sizes and shapes of these metal particles can be adjusted as appropriate in view of the process design and the influence of the thermal history on the battery characteristics.

The resin material for use in the connection electrode 40 may be a thermoplastic resin or a thermosetting resin.

Examples of the thermoplastic resin include a polyethylene resin, a polypropylene resin, an acrylic resin, a polystyrene resin, a vinyl chloride resin, a silicone resin, a polyamide resin, a polyimide resin, a fluorinated hydrocarbon resin, a polyether resin, butadiene rubber, isoprene rubber, styrene-butadiene rubber (SBR), styrene-butadiene-styrene copolymer (SBS), styrene-ethylene-butadiene-styrene copolymer (SEBS), ethylene-propylene rubber, butyl rubber, chloroprene rubber, and acrylonitrile-butadiene rubber.

Examples of the thermosetting resin include:
(i) an amino resin, such as a urea resin, a melamine resin, or a guanamine resin;
(ii) an epoxy resin, such as a bisphenol A epoxy resin, a bisphenol F epoxy resin, a phenol novolac epoxy resin, or an alicyclic epoxy resin;
(iii) an oxetane resin;
(iv) a phenolic resin, such as a resol phenolic resin or a novolac phenolic resin; and
(v) a silicone-modified organic resin, such as a silicone epoxy resin or a silicone polyester resin.

In the connection electrode 40, a material having a pore containing air or the like, an air bubble, or the like may be used. According to such a structure, the softness (e.g., Young's modulus) can be controlled in a wide range. Consequently, it is possible to further relieve stress on the battery 1000 caused by expansion and contraction of the battery element due to a temperature variation.

The connection electrode 40 may contain a non-flammable material such as a metal, a ceramic, or a solid electrolyte. In the case where the connection electrode 40 contains a non-flammable material, the connection electrode 40 also acts effectively as a layer wall suppressing a spreading fire in case of abnormal heating of the battery 1000.

From the viewpoint of the volumetric energy density of the battery, the connection electrode 40 having a smaller thickness is more advantageous. For example, the connection electrode 40 may have a smaller thickness than the current collectors have. The connection electrode 40 may have a thickness of, for example, 1 μm or more and 50 μm or less, or 2 μm or more and 40 μm or less. In the case where the connection electrode 40 has a thickness within the above range, stress caused by expansion and contraction of the current collectors due to a temperature variation is easily relieved while a decrease in volumetric energy density is suppressed. Therefore, the characteristics of the battery 1000 can be stably produced.

According to the above configuration, it is possible to achieve the battery 1000 having excellent input and output characteristics.

In Embodiment 1, the configuration in which the first electrode layer 10 includes the three active material layers has been described. However, the number of the active material layers provided in the first electrode layer 10 is not limited to this, and the first electrode layer 10 may include four or more active material layers. That is, the first electrode layer 10 further includes fourth to N-th active material layers (N is an integer equal to or greater than 4) having the same polarity as the first to third active material layers have, an L-th active material layer (L is an integer satisfying 4≤L≤N) included in the fourth to N-th active material layers is positioned between an L−1-th active material layer and the first solid electrolyte layer 20, and the fourth to N-th active material layers each have a surface in contact with the solid electrolyte. The same applies to the following embodiments described later.

### Embodiment 2

A battery 2000 according to Embodiment 2 will be described below. The matters described in the above embodiment can be omitted.

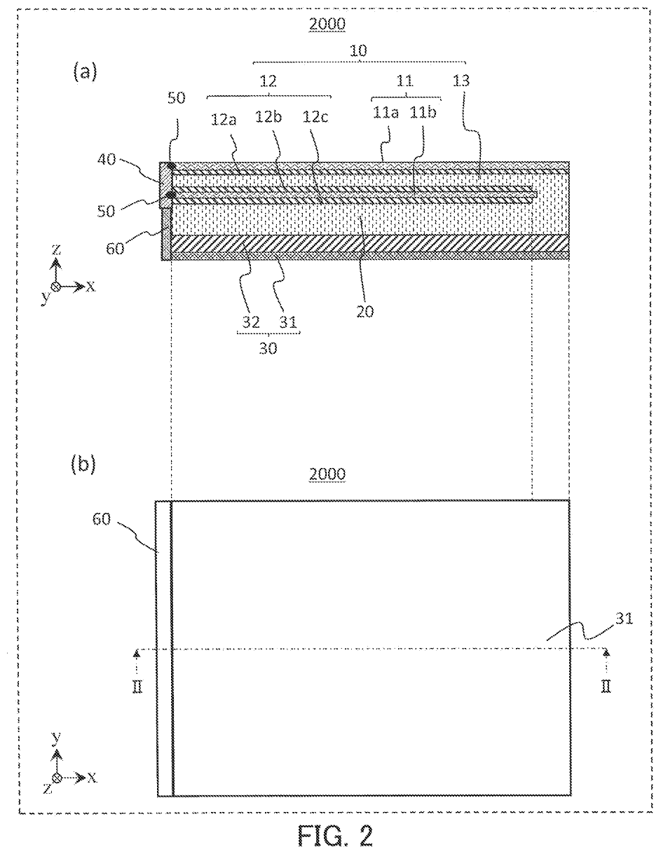

FIG. 2 schematically shows the configuration of the battery 2000 according to Embodiment 2. FIG. 2(a) is a cross-sectional view of the battery 2000 according to Embodiment 2. FIG. 2(b) is a plan view of the battery 2000 as viewed from below in the z-axis direction. In FIG. 2(a), a cross section at the position indicated by line II-II in FIG. 2(b) is shown.

As shown in FIG. 2, the battery 2000 according to Embodiment 2 is different from the battery 1000 in that an insulating layer 60 is formed on the side surface of the battery 2000 on which the connection electrode 40 is disposed, among the side surfaces of the battery 2000.

The material of the insulating layer 60 should have electrical insulating properties. The insulating layer 60 can suppress contact of the connection electrode 40 with the second electrode layer 30 caused by, for example, fall-off of the components of the active material layer 32 of the second electrode layer 30, thereby preventing a short circuit between the first electrode layer 10 and the second electrode layer 30. At least one of the other side surfaces of the battery 2000 may be coated with the insulating layer 60.

An example of the material of the insulating layer 60 is an insulating resin.

The insulating layer 60 may have about the same thickness as the connection electrode 40 has. The insulating layer 60 may have a thickness of, for example, 1 μm or more and 50 μm or less, or 2 μm or more and 40 μm or less.

The material of the insulating layer 60 can be, for example, a liquid or powdery thermosetting epoxy resin. Such an applicable resin material in a liquid or powdery state is applied onto the side surface of the battery 2000 for thermal curing, so that the insulating layer 60 can be fixed to the side surface of the battery 2000. An especially suitable material of the insulating layer 60 is a material softer than the battery constituent members (i.e., the current collectors, the active material, and the solid electrolyte). For example, a material having hardness of a typical epoxy resin having an elastic modulus of 10 to 40 GPa may be used. In this case, on the side surface of the battery 2000, impact can be absorbed by the portion coated with the insulating layer 60 and the portion coated with the connection electrode 40 collectively. Therefore, the battery 2000 can be protected by providing the insulating layer 60.

Moreover, when a thermal cycle acts, the softness of the insulating material of the insulating layer 60 can absorb stress acting on the interface between the insulating layer 60 and the side surface of the battery 2000 and on the interface between the insulating layer 60 and the connection electrode 40 that are caused by the mutual difference in thermal expansion. Therefore, it is possible to suppress an adverse effect on the solid structure of the battery 2000 (e.g., occurrence of cracks) or delamination.

The softness (e.g., Young's modulus) of the battery constituent members and the insulating layer 60 can be evaluated by the method described above for the connection electrode 40. The relative relation in softness between these can be determined by applying a rigid indenter and comparing the magnitude relation in size of the indentation, as in Vickers hardness measurement. For example, it is desirable that when the indenter is pressed against the portions of the cross section of the battery with the same force, the material of the insulating layer 60 becomes recessed more greatly than any other constituent material.

The thermal curing conditions, namely, the temperature and time for thermal curing, may be set to the extent that no adverse effect is exerted on the battery characteristics. The insulating layer 60 having a thickness of especially 10 μm or more is, for example, sufficient for electrical insulation, and a larger thickness is better for impact absorption. Although the upper limit for the thickness is not particularly set, the thickness may be set to an appropriate value in order to suppress a decrease in the energy density and the volumetric capacity density of the battery.

According to such a configuration, it is possible to obtain the battery 2000 having excellent input and output characteristics, a high performance, and a high reliability.

### Embodiment 3

A battery 3000 according to Embodiment 3 will be described below. The matters described in the above embodiments can be omitted.

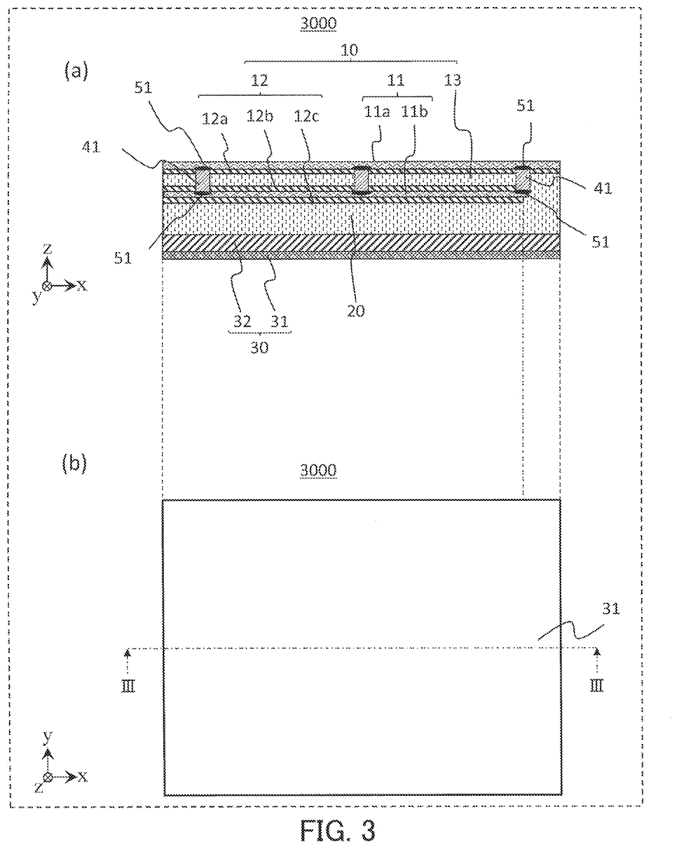

FIG. 3 schematically shows the configuration of the battery 3000 according to Embodiment 3. FIG. 3(a) is a cross-sectional view of the battery 3000 according to Embodiment 3. FIG. 3(b) is a plan view of the battery 3000 as viewed from below in the z-axis direction. In FIG. 3(a), a cross section at the position indicated by line III-Ill in FIG. 3(b) is shown.

As shown in FIG. 3, the battery 3000 is different from the battery 1000 in that a connection electrode 41 is formed by an inner via hole provided inside the battery 3000. That is, in the battery 3000 according to Embodiment 3, the connection electrode 41 is positioned inside the first electrode layer 10.

Since the connection electrode 41 is formed by the inner via hole provided inside the battery, the internal connection can be achieved by via hole connection, which is often used for stacked devices and multi-layer boards. The connection electrode 41 can be incorporated into any place inside the battery, and spreading the positions of the via holes in the upper and lower active material layers makes it possible to spread and relieve stress caused by expansion and contraction of the active material layers. Moreover, the plurality of via electrodes can connect between the upper and lower layers, thereby enhancing reliability in both electrical connection and fixing between the layers. Therefore, the battery 3000 according to Embodiment 3 can have a further enhanced reliability owing to the configuration of the connection electrode 41.

The connection electrode 41 electrically connects the upper and lower collectors (i.e., the first current collector 11a and the second current collector 11b) to each other via an inner via hole. The inner via hole can be formed by a typical process technique for stacked ceramics, which is used for stacked inductors and Low Temperature Co-fired Ceramics (LTCC). For example, a through-hole is provided in the electrode layer with a mechanical puncher or by laser processing, and then filled with a conductive material, for example, by printing using a metal mask. The hole may be, for example, circular (in the shape of a circular column), and may have a diameter of, for example, 100 to 500 μm. Another example of the shape of the hole is a rectangular shape.

The conductive material to fill the via hole should be any conductive material having an electrically high conductivity. For example, the same conductive material as the material of the connection electrode 40 described in Embodiment 1 can be used.

Thus, forming the connection electrode 41 by the via hole makes it possible to incorporate the connection electrode 41 into any place inside the battery. Furthermore, forming the plurality of via hole positions in the upper and lower current collectors (i.e., the first current collector 11a and the second current collector 11b) makes it possible to bind and fix, at the relevant positions, stress caused by expansion and contraction of the electrode layer. Moreover, a reaction layer 51 is diffused so as to be spread beyond the diameter of the connection electrode 41, thereby joining between the layers firmly and integrally. Consequently, it is possible to enhance the effect of suppressing delamination due to expansion and contraction in the battery operation and to enhance reliability in connection as well. Therefore, the battery 3000 has a high performance and a high reliability in addition to excellent input characteristics.

### Embodiment 4

A battery 4000 according to Embodiment 4 will be described below. The matters described in the above embodiments can be omitted.

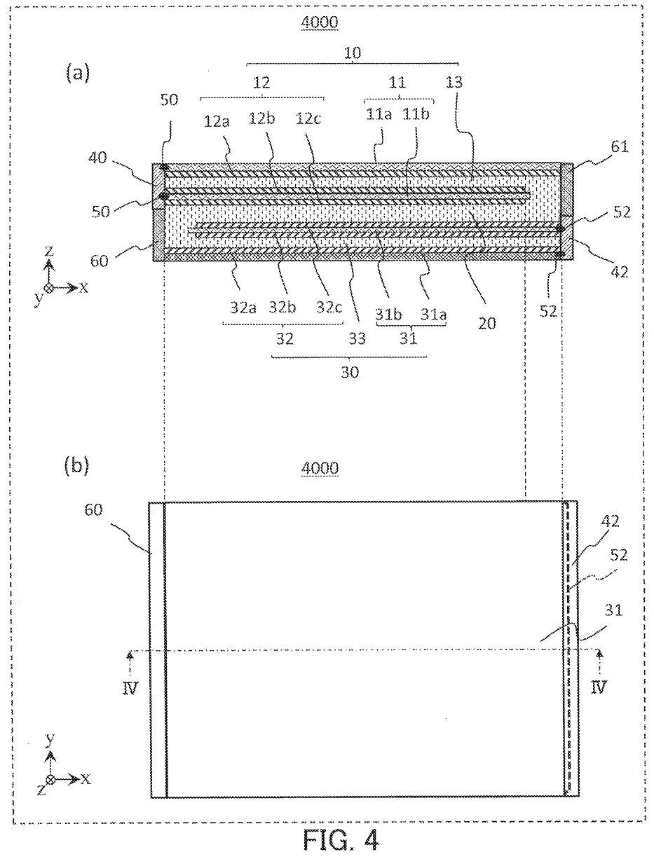

FIG. 4 schematically shows the configuration of the battery 4000 according to Embodiment 4. FIG. 4(a) is a cross-sectional view of the battery 4000 according to Embodiment 4. FIG. 4(b) is a plan view of the battery 4000 as viewed from below in the z-axis direction. In FIG. 4(a), a cross section at the position indicated by line IV-IV in FIG. 4(b) is shown.

As shown in FIG. 4, the battery 4000 is different from the battery 1000 in that the second electrode layer 30 includes a plurality of active material layers. Specifically, the second electrode layer 30 includes a first current collector 31a, a first active material layer 32a, a third solid electrolyte layer 33, a second active material layer 32b, a second current collector 31b, and a third active material layer 32c in this order. The third solid electrolyte layer 33 is disposed between the first active material layer 32a and the second active material layer 32b. In the second electrode layer 30, the third solid electrolyte layer 33 is provided between the first active material layer 32a and the second active material layer 32b. In the second electrode layer 30, the first active material layer 32a, the second active material layer 32b, and the third active material layer 32c are separate from each other and not in direct contact with each other. The second current collector 31b is disposed between the second active material layer 32b and the third active material layer 32c, and is in contact with the second active material layer 32b and the third active material layer 32c. The first active material layer 32a, the second active material layer 32b, and the third active material layer 32c have the same polarity.

In the battery 4000 shown in FIG. 4, the first active material layer 32a and the second active material layer 32b are separate from each other and not in direct contact with each other, and the third solid electrolyte layer 33 is provided in the entire region between the first active material layer 32a and the second active material layer 32b. However, the battery 4000 is not limited to this configuration, and the first active material layer 32a and the second active material layer 32b may have respective portions in direct contact with each other. In this case, the third solid electrolyte layer 33 should be provided in a region that is positioned between the first active material layer 32a and the second active material layer 32b and separates the first active material layer 32a and the second active material layer 32b. To obtain further favorable input and output characteristics, the region, which separates the first active material layer 32a and the second active material layer 32b, may account for, for example, 50% or more of the area of the principal surfaces of the first active material layer 32a and the second active material layer 32b facing each other. Similarly, the second active material layer 32b and the third active material layer 32c may have respective portions in direct contact with each other.

According to the above configuration, as with the first electrode layer 10, it is possible to achieve the second electrode layer 30 with a small thickness into and from which Li ions are easily intercalated and deintercalated. Therefore, even with a reduced size and a further increased capacity, the battery 4000 having a high reliability and excellent input and output characteristics can be obtained.

As with the first electrode layer 10 including the connection electrode 40, the second electrode layer 30 may include a connection electrode 42. As with the first electrode layer 10 including the reaction layer 50, the second electrode layer 30 may include a reaction layer 52. As with the first electrode layer 10 including the insulating layer 60, the second electrode layer 30 may include an insulating layer 61. The material of the connection electrode 42 can be the same as the material of the connection electrode 40 described in Embodiment 1. The material of the insulating layer 61 can be the same as the material of the insulating layer 60 described in Embodiment 2. The reaction layer 52 is the same as the reaction layer 50 described in Embodiment 1.

According to the above configuration, it is possible to enhance the input and output characteristics and increase the capacity by the first electrode layer 10 and the second electrode layer 30.

### Embodiment 5

A stacked battery 5000 according to Embodiment 5 will be described below. The matters described in the above embodiments can be omitted.

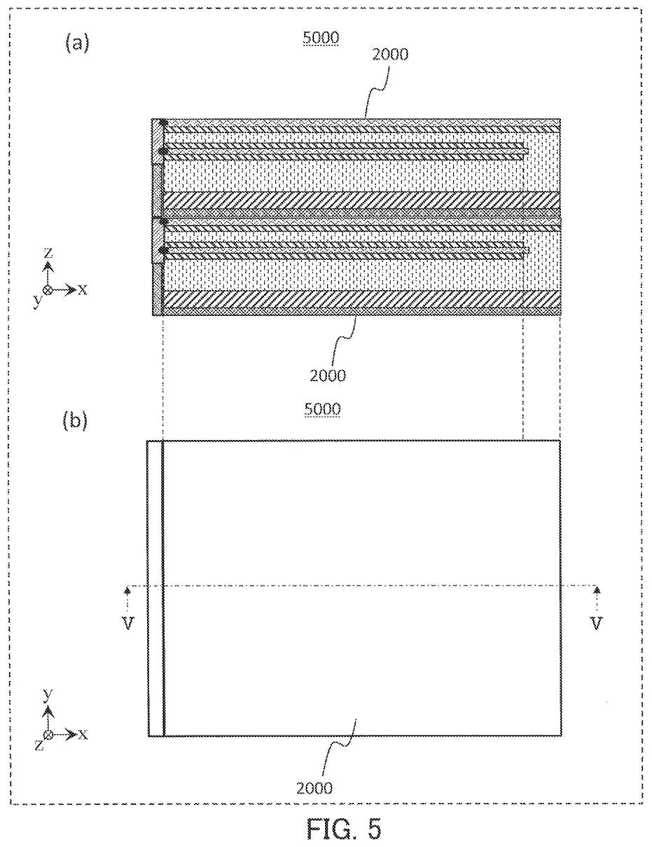

FIG. 5 schematically shows the configuration of the stacked battery 5000 according to Embodiment 5. FIG. 5(a) is a cross-sectional view of the stacked battery 5000 according to Embodiment 5. FIG. 5(b) is a plan view of the stacked battery 5000 as viewed from below in the z-axis direction. In FIG. 5(a), a cross section at the position indicated by line V-V in FIG. 5(b) is shown.

As shown in FIG. 5, the stacked battery 5000 is different from the battery 2000 in that the two batteries 2000 are stacked. That is, the stacked battery 5000 includes the two unit cells.

According to the above configuration, it is possible to achieve a high-performance and high-reliability battery, even with an increased capacity and an increased energy.

The stacked battery 5000 is obtained by stacking the two batteries 2000 with a conductive material applied onto their connection surfaces and curing the conductive material for integration. The conductive material for connection should have conductivity. The conductive material can be, for example, the same as the conductive material of the connection electrode 40 described in Embodiment 1.

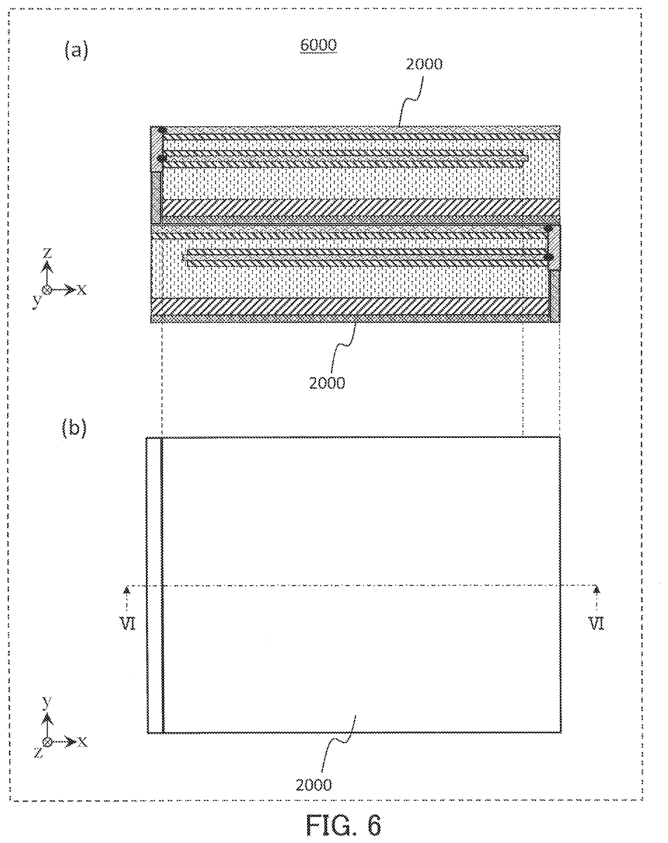

The unit cells included in the stacked battery 5000 may be disposed so as to be oppositely oriented. FIG. 6 schematically shows the configuration of a stacked battery 6000 of a modification according to Embodiment 5. FIG. 6(a) is a cross-sectional view of the stacked battery 6000 of the modification according to Embodiment 5. FIG. 6(b) is a plan view of the stacked battery 6000 as viewed from below in the z-axis direction. In FIG. 6(a), a cross section at the position indicated by line VI-VI in FIG. 6(b) is shown.

The two unit cells are shown in FIG. 5 and FIG. 6. Alternatively, three or more unit cells may be stacked. By, for example, disposing the unit cells so as to be oppositely oriented as shown in FIG. 6 or reducing the position deviation, the stress resistance such as the impact resistance is enhanced. Consequently, a stacked battery having a high reliability can be configured.

According to such a configuration in which a plurality of unit cells are connected to each other, it is possible to achieve a high-performance and high-reliability battery having a high voltage and a high energy amount.

### [Method for Manufacturing Battery]

An example of a method for manufacturing the battery of the present disclosure will be described below. A method for manufacturing the battery 2000 according to Embodiment 2 will be described as an example.

In the following description, the first electrode layer 10 is the positive electrode, and the second electrode layer 30 is the negative electrode.

First, pastes are prepared that are to be used for forming the positive electrode active material layer and the negative electrode active material layer by printing. The solid electrolyte raw material that is prepared for use in each of a mixture for the positive electrode active material layer and a mixture for the negative electrode active material layer is, for example, a Li₂S—P₂S₅-based sulfide glass powder having an average particle diameter of about 10 μm and containing triclinic crystals as its main component. This glass powder has a high ionic conductivity of, for example, about 2×10⁻³ to 3×10⁻³ S/cm. The positive electrode active material that is used is, for example, a Li·Ni·Co·Al composite oxide (e.g., LiNi_{0.8}Co_{0.15}Al_{0.05}O₂) powder having an average particle diameter of about 5 μm and a layered structure. A mixture containing the above positive electrode active material and the above glass powder is dispersed in an organic solvent or the like. Thus, a positive electrode active material layer paste is produced. The negative electrode active material that is used is, for example, a natural graphite powder having an average particle diameter of about 10 μm. A mixture containing the above negative electrode active material and the above glass powder is dispersed in an organic solvent or the like. Thus, a negative electrode active material layer paste is produced.

Subsequently, a copper foil having a thickness of about 30 μm, for example, is prepared as the material for use as the positive electrode current collector and the negative electrode current collector. The copper foil has both sides roughened, for example, and has a maximum height Rz of about 3 to 7 μm. The following parts (A) to (C) are prepared by screen printing.
(A) a part obtained by printing the negative electrode active material layer paste on one side of the negative electrode current collector so as to have a thickness of about 50 to 100 μm and drying the negative electrode active material layer paste at 80° C. to 130° C.: the negative electrode active material layer paste dried has a thickness of 30 μm or more and 60 μm or less.
(B) a part obtained by printing the positive electrode active material layer paste on one side of the positive electrode current collector so as to have a thickness of about 50 to 100 μm and drying the positive electrode active material layer paste at 80° C. to 130° C.: the positive electrode active material layer paste dried has a thickness of 30 μm or more and 60 μm or less.
(C) a part obtained by printing the positive electrode active material layer paste on each of the both sides of the positive electrode current collector so as to have a thickness of about 50 to 100 μm and drying the positive electrode active material layer paste at 80° C. to 130° C.: the positive electrode active material layer paste dried has a thickness of 30 μm or more and 60 μm or less.

Thus, the following is obtained: a negative electrode layer in which a negative electrode active material layer is formed on the one side of the copper foil as the negative electrode current collector (i.e., the above part (A)); a positive electrode layer in which a positive electrode active material layer is formed on the one side of the copper foil as the positive electrode current collector (i.e., the above part (B)); and a positive electrode stack in which a positive electrode active material layer is formed on each of the both sides of the copper foil as the positive electrode current collector (i.e., the above part (C)).

Subsequently, a mixture containing the above glass powder is dispersed in an organic solvent or the like to produce a solid electrolyte layer paste. On each of the negative electrode active material layer of the negative electrode layer, the positive electrode active material layer of the positive electrode layer, and the positive electrode active material layers formed on the both sides of the positive electrode stack, the above solid electrolyte layer paste is printed with a metal mask so as to have a thickness of, for example, about 100 μm. Thereafter, the negative electrode layer, the positive electrode layer, and the positive electrode stack, on which the solid electrolyte layer paste is printed, are dried at 80° C. to 130° C.

Subsequently, the negative electrode layer, the positive electrode stack, and the positive electrode layer are laid one on top of another in this order. At this time, the positive electrode layer, the positive electrode stack, and the negative electrode layer are stacked one on top of another so that: the solid electrolyte printed on the positive electrode active material layer of the positive electrode layer faces the solid electrolyte printed on one of the positive electrode active material layers of the positive electrode stack; and the solid electrolyte printed on the other positive electrode active material layer of the positive electrode stack faces the solid electrolyte printed on the negative electrode active material layer of the negative electrode layer.

Subsequently, the stack thus obtained is pressed with a press die. Specifically, an elastic sheet having a thickness of 70 μm and an elastic modulus of about 5×10 6 Pa, for example, is inserted between the stack and each of the press die plates, that is, onto the upper surface of the negative electrode current collector of the stack and onto the upper surface of the positive electrode current collector constituting the positive electrode layer. According to this configuration, a pressure is applied to the stack through the elastic sheets. Thereafter, the stack is pressed for 90 seconds while the press die is heated to 50° C. at a pressure of 300 MPa.

Subsequently, on the side surface of the positive electrode layer, a thermosetting conductive paste is printed by screen printing so as to have a thickness of about 30 μm. In the thermosetting conductive paste, a low-melting metal (e.g., Sn) is contained in conductor particles such as Ag particles having an average particle diameter of 0.5 μm. Thereafter, the thermosetting conductive paste is cured, for example, at 150° C. to 200° C. for 0.5 hours to 3 hours to form a connection electrode. Stacking may be employed as necessary for a desired thickness. During this curing treatment, a reaction layer is formed between the current collector and the connection electrode, and the current collector and the connection electrode are integrated. To form a thin coating film, finer particles or flaky particles may be used instead of conductor particles such as Ag particles. Moreover, various low-melting metals may be contained for the purpose of forming an alloy with the current collector at the curing temperature.

Subsequently, onto a side surface of the battery on which no connection electrode, a thermosetting epoxy resin is applied by screen printing so as to have a thickness of about 30 μm (about the same thickness as the thickness of the connection electrode). Thereafter, the thermosetting epoxy resin is cured at a temperature of about 120 to 150° C. for 1 hour to 3 hours, cooled to room temperature, and taken out. Thus, the battery 2000 is obtained.

The method and order of forming the battery are not limited to the above example.

The above manufacturing method illustrates the example in which the positive electrode active material layer paste, the negative electrode active material layer paste, the solid electrolyte layer paste, and the conductive paste are applied by printing. However, printing is not limited to this. The printing method may be, for example, a doctor blade method, a calendering method, a spin coating method, a dip coating method, an inkjet method, an offset method, a die coating method, or a spray method.

The above manufacturing method illustrates, as the conductive paste, a thermosetting conductive paste containing Ag particles. However, the conductive paste is not limited to this. The conductive paste may be a thermosetting conductive paste containing highly conductive metal particles with a high melting point (e.g., 400° C. or higher), low-melting metal particles, and a resin. The low-melting metal particles should desirably have a melting point equal to or lower than the curing temperature of the conductive paste, and have a melting point of, for example, 300° C. or lower. Examples of the material of the high-melting and highly conductive metal particles include silver, copper, nickel, zinc, aluminum, palladium, gold, platinum, and an alloy obtained by any combination of these metals. Examples of the material of the low-melting metal particles with a melting point of 300° C. or lower include tin, a tin-zinc alloy, a tin-silver alloy, a tin-copper alloy, a tin-aluminum alloy, a tin-lead alloy, indium, an indium-silver alloy, an indium-zinc alloy, an indium-tin alloy, bismuth, a bismuth-silver alloy, a bismuth-nickel alloy, a bismuth-tin alloy, a bismuth-zinc alloy, and a bismuth-lead alloy. Using a conductive paste containing such low-melting metal particles proceeds with solid-phase and liquid-phase reactions at contact sites between the metal particles contained in the conductive paste and the metal constituting the current collectors, even at a thermal curing temperature lower than the melting point of the high-melting and highly conductive metal particles. Consequently, at the interface between the conductive paste and the surfaces of the current collectors, the solid-phase and liquid-phase reactions form an alloy diffusing around the above contact sites. The alloy to be formed is, for example, a silver-copper alloy, which is a highly conductive alloy, in the case where silver or a silver alloy is used as the conductive metal particles and copper is used as the current collectors. Furthermore, the conductive metal particles and the current collectors can be combined to form a silver-nickel alloy, a silver-palladium alloy, or the like as well. According to this configuration, the connection electrode and the current collectors are more firmly joined to each other. For example, it is possible to suppress peeling off of the joined portion due to a thermal cycle or impact.

The shapes of the high-melting and highly conductive metal particles and the low-melting metal particles are not limited. Examples of the shapes include a spherical shape, a flaky shape, and an acicular shape. The particle sizes of the high-melting and highly conductive metal particles and the low-melting metal particles are not limited. For example, particles having a smaller particle size proceed with an alloying reaction and diffusion of the alloy at a lower temperature, and accordingly the particle sizes and shapes are selected as appropriate in view of the process design and the influence of the thermal history on the battery characteristics.

The resin for use in the thermosetting conductive paste should be any resin serving as the binder. Furthermore, an appropriate resin with suitable printing performance, application performance, or the like is selected depending on the manufacturing process to be employed. The resin for use in the thermosetting conductive paste includes, for example, a thermosetting resin. Examples of the thermosetting resin include:
(i) an amino resin, such as urea resin, a melamine resin, or a guanamine resin;
(ii) an epoxy resin, such as a bisphenol A epoxy resin, a bisphenol F epoxy resin, a phenol novolac epoxy resin, or an alicyclic epoxy resin;
(iii) an oxetane resin;
(iv) a phenolic resin, such as a resol phenolic resin or a novolac phenolic resin; and
(v) a silicone-modified organic resin, such as a silicone epoxy resin or a silicone polyester resin. The resin may be only one of these materials or a combination of two or more of the materials.

### INDUSTRIAL APPLICABILITY

The battery according to the present disclosure can be used, for example, as a secondary battery such as an all-solid-state battery for use in various electronic devices, automobiles, and the like.

What is claimed is:

1. A battery comprising, in the following order:
a first electrode layer;
a first solid electrolyte layer; and
a second electrode layer, wherein
the first electrode layer includes:
a first active material layer;
a second active material layer positioned between the first active material layer and the first solid electrolyte layer, the second active material layer having the same polarity as the first active material layer has; and
a second solid electrolyte layer positioned between the first active material layer and the second active material layer, and
the second solid electrolyte layer is continuous with the first solid electrolyte layer.

2. The battery according to claim 1, wherein
the first active material layer is separate from the second active material layer.

3. The battery according to claim 1, wherein
the first electrode layer further includes a first current collector, and
the first current collector is in contact with the first active material layer.

4. The battery according to claim 3, wherein
the first current collector includes at least one selected from the group consisting of Al, Cu, and Ni.

5. The battery according to claim 1, wherein
the first electrode layer further includes a second current collector, and
the second current collector is in contact with the second active material layer.

6. The battery according to claim 5, wherein
the first electrode layer further includes a third active material layer,
the third active material layer has the same polarity as the first active material layer and the second active material layer have, and
the second current collector is disposed between the second active material layer and the third active material layer.

7. The battery according to claim 5 having a region where the second current collector is present and the second active material layer is not present in plan view.

8. The battery according to claim 5, wherein
the second current collector has at least one selected from the group consisting of a hole and a slit.

9. The battery according to claim 1, wherein
the first active material layer is electrically connected in parallel to the second active material layer.

10. The battery according to claim 9 further comprising a connection electrode, wherein
the connection electrode electrically connects the first active material layer and the second active material layer to each other.

11. The battery according to claim 10, wherein
the connection electrode is provided on a side surface of the battery.

12. The battery according to claim 10, wherein
the connection electrode is positioned inside the first electrode layer.

13. The battery according to claim 10, wherein
the connection electrode includes a first metal material and at least one selected from the group consisting of a resin material and a solid electrolyte.

14. The battery according to claim 13, wherein
the connection electrode further includes a second metal material, and
the second metal material has a lower melting point than the first metal material has.

15. The battery according to claim 14, wherein
the second metal material includes at least one selected from the group consisting of Sn, In, and Bi.

16. The battery according to claim 14 further comprising a reaction layer disposed between the first current collector and the connection electrode, wherein
the reaction layer includes the second metal material.

17. The battery according to claim 1, wherein
the second electrode layer includes a plurality of active material layers.

18. The battery according to claim 1, wherein
in plan view, the second active material layer is smaller than the first active material layer.

18. The battery according to claim 1, wherein
in plan view, the second active material layer is smaller than the first active material layer.

19. The battery according to claim 1, wherein
the first electrode layer further includes a first current collector in contact with the first active material layer and a second current collector in contact with the second active material layer and
in plan view, the second current collector is smaller than the first current collector.

20. A stacked battery comprising a plurality of the batteries according to claim 1, wherein
the plurality of batteries are stacked so as to be electrically connected in series or in parallel.
